(19) United States
(12) Patent Application Publication
(10) Pub. No.: US 2004/0072129 A1
(43) Pub. Date: Apr. 15, 2004

(54) Lifetime memories remembrance program system and method

(76) Inventor: Richard L. Arnoldy, Rothschild, WI (US)

Correspondence Address: MERCHANT & GOULD PC, P.O. BOX 2903, MINNEAPOLIS, MN, 55402-0903, US

(21) Appl. No.: 10/269,236

(22) Filed: Oct. 11, 2002

(51) Int. Cl. G09B 19/00

(52) U.S. Cl. 434/154

(57) ABSTRACT

A system and method for establishing and administrating a short term or perpetual remembrance program is disclosed.

### Field of the Invention

The present invention is directed to a program for passing on a person's legacy to their descendants. More specifically, the invention is directed to a method and system for allowing a person's descendants to learn about them and receive a regular photo card, other identification information, and/or optional presents from that person.

### BACKGROUND

One of the great joys in life is the love and kindness that often exists between generations of a family. Being a grandparent is one of the happiest roles of many people's lives, and the bond a grandchild forms with a grandparent can be one of the most loving and nurturing relationships a child will have. Similarly, for a child fortunate to know his or her great grandparents, a special bond can form as the child gets to learn about the “old days” and discover firsthand a bygone world from someone who both lived through it and is also a direct ancestor.

The joys of getting to know one's ancestors are many fold, and certainly the direct contact with an ancestor is irreplaceable. Nothing can replace getting to know your ancestors in person. However, many of the benefits of knowing one's ancestors are abstract and not necessarily contingent upon actually knowing that ancestor. For example, an appreciation of one's ancestors can be critical to giving an individual a cultural identity. Similarly, appreciation of one's ancestors gives a sense of continuity in a world that seems to change more rapidly every year. This sense of cultural identity and continuity are valuable even if a person does not personally know all of their ancestors.

Today, many people are choosing to have children when they are much older, as was not the case in earlier generations. Increasingly, children are born to parents who are in their thirties and forties. The parents of these children are sometimes quite old before their grandchildren are born, and thus the grandparents do not always have a good chance to get to know the grandchildren while the grandparent is still alive and active. Although people are living longer lives, the fact that children are being born to older parents remains a considerable limitation to multi-generation families getting to know one another. If it is sometimes difficult for a child to get to know his or her grandparents, it is even less common to know great grandparents, and almost unheard of to know one's great, great grandparents, much less even earlier generations.

Therefore, a need exists for a way to allow a child to learn about his or her ancestors and for grandparents not to be forgotten by present and future generations. This invention seeks to satisfy that need.

### SUMMARY OF THE INVENTION

The present invention is directed to a program, whether short term or perpetual, that permits ancestors to impact and influence their offspring through regular photo cards, optional gifts, and optional financial disbursements. Unlike traditional trusts and financial planning instruments, the purpose of the present program is generally to allow mostly non-financial contributions to a young person's life. For example, these contributions may be photo cards, digital pictures, emails, voice or video messages, telegrams, personal message services, photographs, small gifts, or notes sent from the ancestor to some or all present and designated future descendants. The program is designed to promote remembrances of the ancestors, and as such is referred to as a “remembrance program” in this disclosure.

Generally these contributions are sent during a recipient's youth, normally while the recipient is old enough to appreciate them but not so old as to disregard them. For example, in certain implementations of the invention the contributions are sent to a donor after they are in preschool but stop before they are an adult. In one such implementation the contributions are sent once the recipient reaches age 7 but stop before they reach age 13.

In most implementations of the invention a donor sets up an irrevocable account that contains money for the donations, identifies current descendants, and selects the manner in which the descendants shall receive the donations, whether they be photo cards, or other optional contributions. For example, if money is given as a donation, the amount of money can be a one-time donation or a series of donations over a pre-determined time.

The list of current descendants is likely to include a person's daughters and sons, but could also include nieces and nephews or other persons designated by the donor. Grandchildren and great grandchildren would typically also be listed including future descendants.

The manner in which the descendants shall receive donations can be as simple as an annual birthday card or as complicated as a series of annual cards, pictures, and gifts. In most cases it is desirable to have the donations somehow increase the recipients' understanding, knowledge, and appreciation of the donor. For example, the donations can include notes from the donor or pictures of the donor. Preferably the donations have a timeless quality that can be appreciated by numerous future generations. For example, a donation given to a recipient on his or her 10th birthday can be very meaningful if it included a photograph of the donor on his or her 10th birthday, along with a possible short note about what life was like on that 10th birthday.

In certain aspects the invention is directed to a method of providing ancestor information (e.g., a family tree ) to a descendant, the method having the steps of identification of one or more descendants who shall receive information about one or more ancestors; identification of one or more future dates for receipt of the information by the one or more descendants; selection of biographical or historical material about the one or more ancestors; associating the identified future dates with the selected biographical or historical material; and distributing the selected biographical or historical material about the one or more ancestors to the one or more descendants on the basis of the association of the identified future dates with the selected biographical or historical material.

The identification of one or more descendants who shall receive information about their ancestors can include selecting existent descendants who shall receive the information; plus a protocol for identification of non-existent descendant who shall receive the information. Alternatively, the identification of one or more descendants who shall receive information about the one or more ancestors comprises identification of all existent descendants plus all future descendants when born. Thus, in some implementations the method includes selection of a descendant identification procedure for use in identification of future descendants.

The step of identification of one or more future dates for receipt of the information by the one or more ancestors can include, for example, identification of the birthdays, anniversaries, holidays and ceremonies of the one or more descendants. The step of selection of biographical or historical material about the one or more ancestors can include, for example, the selection of photographs and historic documents. Also, this step may further include generating correspondence to be provided to the one or more descendants at a subsequent predetermined date. It can also include recording a video image, recording an oral statement, or recording a written or typed statement.

The step of associating the identified future dates with the selected biographical or historical material typically includes correlating biographical or historical material of the ancestor to future dates at which the one or more descendants are believed to have heightened interest in the biographical or historical material of their ancestor.

This summary of the invention is not intended to limit the scope of the invention described herein, but is provided merely to provide a basic summary thereof. The invention will now be described in greater detail by reference to the following detailed description and claims.

### DETAILED DESCRIPTION

The method and system of the invention are designed so that a person (an ancestor) can have ongoing contact with their current and future direct descendants (or other identified persons), even if the ancestor is incapacitated or deceased. The present invention meets an important human desire of the ancestor to be in contact with and have a lasting relationship with their descendants. Preferably, such relationships are very personal, and long lasting. Unfortunately, it is impossible to know when someone will become incapacitated or die, and thus it is often not possible to assure that a relationship will continue or form. The present invention is directed to essentially creating and/or maintaining this relationship by assuring an ancestor that their descendants will have at least a minimum of familiarity with them.

The present invention permits ancestors to impact and influence their offspring through regular photo cards, gifts, and optional financial disbursements. Unlike traditional trusts and financial planning instruments, the purpose of the present remembrance program is to provide primarily a lifelong ancestral memory to a young person's life. For example, these memories may be photo cards, emails, telegrams, voice or video messages, personal message services, photographs, optional small gifts, or notes sent from the ancestor. Generally these remembrances are sent during a recipient's youth, normally while the recipient is old enough to appreciate them but not so old as to disregard them. For example, in certain implementations of the invention the contributions are sent to a descendant after they are in preschool but stop before they are an adult.

In some implementations of the invention the descendants or other recipients may be limited to simply a first generation of descendants or ultimately all future generations, while in other implementations the recipients will include, or even be limited to, a second generation. Generally the recipients will not receive remembrances their entire life, but only during their formative years after they are able to understand the content of the information or optional gift they are receiving. In some implementations the recipient receives the information from ages 7 through 12, while in other implementations it is from ages 5 to 15.

In most implementations of the invention a donor sets up a contract and an account that contains money, identifies current descendants, and extends the contract to all future direct descendants and selects the manner in which the descendants shall receive the photo card and optional contributions. For example, the amount of money can be a one-time donation or a series of donations over time. The list of current descendants is likely to include a person's daughters and sons, but could also include nieces and nephews or other persons designated by the same or different donor. Grandchildren and great grandchildren and all future direct descendants would typically also be listed.

The manner in which all direct descendants shall receive donations can be as simple as an annual ancestor photo birthday card or as complicated as a series of annual photo cards, pictures, and gifts. In most cases it is desirable to have the optional donations somehow increase the recipient's understanding, knowledge, and appreciation of the donor. For example, the donations can include notes from the donor or pictures of the donor. Preferably the donations have a timeless quality that can be appreciated by numerous future generations. For example, a donation given to a recipient on his or her 10th birthday can be very meaningful if the contribution included a photograph of the donor on his or her 10th birthday, along with a short note about what life was like on their 10th birthday.

In addition to receiving the information over the specified time, in certain implementations the recipients also get a cumulative set of the information (such as a family tree) upon reaching a certain date, for example the age of 21. In this manner all of the various cards, photographs, and notes that were sent over the years and possibly lost by their young recipients are sent a second time to the recipients so they can have a complete set. Repeat sending of items is particularly useful when they are in an electronic media, such as digital or scanned photographs, videos, voice recordings, or email notes. However, even hand written cards can be sent a second time if they have been digitized (or, less commonly, filled out twice).

In most implementations the donation will be received by a recipient at a specific time. This date can be, for example, the birthday of the descendant or a significant holiday. There can be a main date on which significant gifts or cards are given, plus other dates for lesser remembrances. Also, the donor can select optional groups of dates, such as those based on nationality or interests (sports, culture, etc.). Thus, a card or note could go out on the start of the fishing season if the donor enjoyed fishing. Alternately, a card could go out on the first day of spring if the donor was an avid gardener.

Typically the donation is a photo card of the ancestor, which can be electronic or non-electronic, and which can optionally include pictures, etc. The card can include a note that describes the world the ancestor lived in or a message to the descendant. Thus, some information can be generic and describe news clippings from that date, etc., while the other information is specific to the donor. In general it is desired to be as sincere as possible, therefore typically not computer generated letters, etc., unless preselected by the ancestor.

In certain aspects the invention is directed to a method of providing ancestor information to a descendant, the method having the steps of identification of one or more descendants who shall receive information about one or more ancestors; identification of one or more future dates for receipt of the information by the one or more ancestors; selection of biographical or historical material about the one or more ancestors; associating the identified future dates with the selected biographical or historical material; and distributing the selected biographical or historical material about the one or more ancestors to the one or more descendants on the basis of the association of the identified future dates with the selected biographical or historical material.

The identification of one or more descendants who shall receive information about one or more ancestors can include selecting existent descendants who shall receive the information; plus a protocol for identification of non-existent descendant who shall receive the information. Alternatively, the identification of one or more descendants who shall receive information about one or more ancestors comprises identification of all existent descendants plus all future descendants when born. Thus, in some implementations the method includes selection of a descendant identification procedure for use in identification of and to all future direct descendants.

The step of identification of one or more future dates for receipt of the ancestral information by the one or more descendants can include, for example, identification of the birthdays, anniversaries, holidays and ceremonies of the one or more descendants. The step of selection of biographical or historical material about the one or more ancestors can include, for example, the selection of photographs and historic documents. Also, this step may further include generating correspondence to be provided to the one or more descendants at a subsequent pre-determined date. It can also include recording a video image, recording an oral statement, a holographic image, or recording a written or typed statement.

The step of associating the identified future dates with the selected biographical or historical material typically includes correlating biographical or historical material of the ancestor to future dates at which the one or more descendants are believed to have heightened interest in the biographical or historical material.

In one implementation of the invention one of the first tasks accomplished by the donor is to make a number of initial selections, which includes a list of recipients (typically descendants), material or information to be provided to these recipients (such as photos), and the amount and timing of optional financial donations that may be given, if any.

In general the amount of the non-refundable principal given to fund the method and system is a fixed amount. This amount can simply be used as a prepayment for the services to be provided in the future, or can be used as a deposit that is placed in trust and then used over time to pay for the optional benefits dependent upon how well the trust performs. Typically, the system also includes a hierarchy of what services will be provided if the fund does not perform well. In general the focus of the fund is to provide meaningful contact with all the descendants and extend to their genealogy for all future direct descendants as opposed to financial rewards. Therefore, in most implementations of the invention, an under-performing trust account will result in the diminishment or elimination of any optional financial payments to ancestors, while the other information (such as cards, photographs, videos, etc.) will continue.

When an optional financial gift is given to subsequent generations the amount of such gifts is preferably increased over time to maintain relative purchasing power, if possible, despite any inflation. Such relative purchasing power is preferably maintained by having the original principal increase in value by accumulating interest over time.

Typically the principal is non-refundable to the donor (ancestor) or recipients (descendants). The donations can be given during the life of the donor, can be given at the donors death (such as in the will), or can be given by other persons after the death of the ancestor. In the latter case the ancestor is not necessarily the donor, but is still the subject of the gift. For example, after a grandparent dies his or her children may wish to fund a remembrance program for the descendants of this grandparent, in particular the grandchildren and great grandchildren.

In certain implementations more than one donor is part of the program, such as a married couple that make donations together. In other implementations the current descendants may fund the existing program for their future direct descendants or be the originator of another program for their direct descendants.

In general it is desirable that the program be able to run in perpetuity. This can be accomplished by making sure that the original principal and any future funds to the existing program are properly invested, to insure the program will automatically continue and extend to their descendants for all future direct descendants, by limiting the amount of annual expenses and distributions, as well as properly predicting the average number of descendants a person will have. In many industrialized countries the population is only barely replacing itself, which is generally a level that a woman will have on average two children or just more than two children (more than two children is necessary to account for children who do not reach adulthood, and thus do not reach the age at which they can have children). It is also necessary to factor in the parental age at which children will be born on average. If parents are having children later in life, then each generation of recipients has a longer period of time for the principal to grow.

The foregoing specification is provided to illustrate aspects of the invention, but is not written to limit the scope thereof; rather it is the purpose of the claims, and their equivalencies, to define the specific invention.

I claim:

1. A method of providing ancestor information which will continue automatically and extend to their genealogy for all current and future direct descendants, the method comprising:
a) identification of one or more descendants who shall receive information about one or more ancestors, which shall automatically continue and extend to all future direct descendants;
b) identification of one or more future dates for receipt of the information by the one or more ancestors;
c) selection of biographical or historical material about the one or more ancestors;
d) associating the identified future dates with the selected biographical or historical material;
e) distributing the selected biographical or historical material about the one or more ancestors to the one or more descendants on the basis of the association of the identified future dates with the selected biographical or historical material;
f) identification of one or more descendants who shall receive information about one or more ancestors while the ancestors are living or deceased; and
g) identification of one or more future descendants who may wish to become a donor ancestor of the remembrance program to ensure their ancestral memory to their descendants.

2. The method of claim 1, wherein the identification of one or more descendants who shall receive information about one or more ancestors comprises selecting:
a) existent descendants who shall receive the information; and
b) a protocol for identification of non-existent descendants who shall automatically receive the information.

3. The method of claim 1, wherein the identification of one or more descendants who shall receive information about one or more ancestors comprises identification of all existent descendants plus all future direct descendants when born.

4. The method of claim 1, further comprising selection of a descendant identification procedure for use in identification of future direct descendants.

5. The method of claim 1, wherein the step of identification of one or more future dates for receipt of the information from the one or more ancestors comprises identification of the birthdays, anniversaries, holidays, and ceremonies of the one or more descendants.

6. The method of claim 1, wherein the step of selection of biographical or historical material about the one or more ancestors comprises the selection of photographs and historic documents.

7. The method of claim 1, further comprising generating correspondence to be provided to the one or more descendants at a subsequent pre-determined date.

8. The method of claim 1, wherein generating correspondence comprises recording a video image, recording an oral statement, or recording a written or typed statement.

9. The method of claim 1, wherein associating the identified future dates with the selected biographical or historical material comprises correlating biographical or historical material of the ancestor to future dates at which the one or more descendants are believed to have heightened interest in the biographical or historical material.

10. A system configured and arranged to providing ancestor information to one or more descendants, the system comprising:
a) means for identification of one or more descendants who shall receive information about one or more ancestors, which shall automatically continue and extend to all future direct descendants and a means for identification of one or more future dates for receipt of the information by the one or more ancestors;
b) means for selection of biographical or historical material about the one or more ancestors and for associating the identified future dates with the selected biographical or historical material; and
c) means for distributing the selected biographical or historical material about the one or more ancestors to the one or more descendants on the basis of the association of the identified future dates with the selected biographical or historical material.

11. The system of claim 10, wherein the means for the identification of one or more descendants who shall receive information about one or more ancestors permits selection of existent descendants who shall receive the information; plus a protocol for identification of non-existent descendants who shall automatically receive the information.

12. The system of claim 10, wherein the means of identification of one or more future dates for receipt of the information from the one or more ancestors comprises identification of the birthdays, anniversaries, holidays, and ceremonies of the one or more descendants.

13. The system of claim 1, wherein the means for associating the identified future dates with the selected biographical or historical material comprises correlating biographical or historical material of the one or more ancestors to future dates at which the one or more descendants are believed to have heightened interest in the biographical or historical material.
